(19) United States
(12) Patent Application Publication
(10) Pub. No.: US 2022/0012553 A1
(43) Pub. Date: Jan. 13, 2022

(54) Color Validation Apparatus, Color Validation Method and Computer-Readable Recording Medium

(71) Applicant: KONICA MINOLTA, INC., Tokyo (JP)

(72) Inventor: Xingyue LI, Amagasaki-shi (JP)

(73) Assignee: KONICA MINOLTA, INC., Tokyo (JP)

(21) Appl. No.: 17/370,404

(22) Filed: Jul. 8, 2021

(30) Foreign Application Priority Data
Jul. 10, 2020 (JP) 2020-119014

(51) Int. Cl. G06K 15/02; G06K 15/00

(52) U.S. Cl. CPC G06K 15/027; G06K 15/1806; G06K 15/007

(57) ABSTRACT

In accordance with a user operation, an apparatus obtains one or more designated positions on an image, the one or more designated positions being one or more positions at which each of one or more designated colors designated for printing of the image is to be printed. The apparatus generates a printing file for causing a printer to print a patch of each of the one or more designated colors on a sheet at a position corresponding to each of the one or more designated positions for the designated color. The apparatus performs color verification based on a colorimetry value on the sheet having the patch printed thereon at the position corresponding to each of the one or more designated positions and a target value for the designated color corresponding to the designated position.

The entire disclosure of Japanese Patent Application No. 2020-119014, filed on Jul. 10, 2020, is incorporated herein by reference in its entirety.

### BACKGROUND

### Technological Field

The present disclosure relates to a color verification apparatus, a color verification method, and a computer-readable recording medium, particularly, to a color verification apparatus, a color verification method, and a computer-readable recording medium, each of which uses colorimetry.

### Description of the Related Art

In a printing industry, color verification is performed in order to maintain excellent printing quality. For example, in a colorimetry value detection system of Japanese Laid-Open Patent Publication No. 2019-100864, a guide rail is provided with a guide groove having a length or width formed along the longitudinal direction thereof, and is set on a printed material by a user such that a colorimetry position of the printed material or an object including the colorimetry position is positioned in the guide groove. Then, a manual colorimeter is moved along the guide groove of the guide rail in accordance with an operation by the user so as to perform measurement of a color (colorimetry) of the colorimetry position of the printed matter or the object including the colorimetry position (see paragraph 0018).

Japanese Laid-Open Patent Publication No. 2016-70697 discloses a measurement position presentation method including: a determination step of determining, based on printing image data, in advance a measurement position for measuring quality of a printed material on which an image is printed; a generation step of generating a measurement position presentation guide indicating the measurement position of the printed material based on the printing image data; and a presentation step of presenting the measurement position by disposing a measurement position presentation guide on the printed material. In the generation step, a process of cutting out a portion corresponding to the measurement region of the measurement position presentation guide is performed.

### SUMMARY

In order to specify a position to be subjected to the colorimetry for color verification, in Japanese Laid-Open Patent Publication No. 2019-100864, the user moves the manual colorimeter along the guide groove of the guide rail. On the other hand, Japanese Laid-Open Patent Publication No. 2016-70697 uses a special mechanism for cutting out the portion corresponding to the measurement region of the measurement position presentation guide. Therefore, for the color verification, a demand arises in a system that can designate a colorimetry position by a simple operation without requiring a special mechanism.

To achieve at least one of the abovementioned objects, according to an aspect of the present invention, a color verification apparatus reflecting one aspect of the present invention comprises a hardware processor. In accordance with a user operation, the hardware processor obtains one or more designated positions on an image, the one or more designated positions being one or more positions at which each of one or more designated colors designated for printing of the image is to be printed, the hardware processor generates a printing file for causing a printer to print a patch of each of the one or more designated colors on a sheet at a position corresponding to each of the obtained one or more designated positions for the designated color, and the hardware processor performs color verification based on a colorimetry value on the printed sheet at the position corresponding to each of the one or more designated positions and a target value for the designated color corresponding to the designated position.

To achieve at least one of the abovementioned objects, according to an aspect of the present invention, a color verification method reflecting one aspect of the present invention comprises: in accordance with a user operation, obtaining one or more designated positions on an image, the one or more designated positions being one or more positions at which each of one or more designated colors designated for printing of the image is to be printed; generating a printing file for causing a printer to print a patch of each of the one or more designated colors on a sheet at a position corresponding to each of the obtained one or more designated positions for the designated color; and performing color verification based on a colorimetry value on the printed sheet at the position corresponding to each of the one or more designated positions and a target value for the designated color corresponding to the designated position.

To achieve at least one of the abovementioned objects, according to an aspect of the present invention, a computer-readable recording medium reflecting one aspect of the present invention is provided, the computer-readable recording medium being a computer-readable recording medium that stores a program for causing a computer to perform the above-described color verification method.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a configuration diagram of a system according to the present embodiment.

FIG. 2 is a schematic diagram showing an internal configuration of an image forming apparatus 100.

FIG. 3 is a diagram schematically showing an exemplary module configuration of image forming apparatus 100.

FIG. 4 is a diagram schematically showing an exemplary hardware configuration of a server 300.

FIG. 5 is a diagram schematically showing an exemplary hardware configuration of an information processing apparatus 200.

FIG. 6 is a diagram schematically showing a module configuration of the color verification system according to the present embodiment.

FIG. 7 is a diagram showing an exemplary browser screen (target configuration creation screen).

FIG. 8 is a diagram showing an exemplary browser screen (colorimetry position designation screen).

FIG. 9 is a diagram showing an exemplary browser screen (colorimetry creation screen).

FIG. 10 is a diagram showing an exemplary colorimetry file.

FIG. 11 is a diagram showing an exemplary colorimetry file.

FIG. 12 is a diagram showing an exemplary colorimetry file.

FIG. 13 is a diagram showing an exemplary browser screen (colorimetry screen).

FIG. 14 is a diagram showing an exemplary browser screen (colorimetry result screen).

FIG. 15 is a diagram showing an exemplary browser screen (report screen).

FIG. 16 is a flowchart of a target configuration creation process according to the embodiment of the present invention.

FIG. 17 is a flowchart of a colorimetry process according to the embodiment of the present invention.

FIG. 18 is a flowchart of a colorimetry file creation process according to the embodiment of the present invention.

FIG. 19 is a flowchart of a color verification process according to the embodiment of the present invention.

FIG. 20 is a flowchart of a report creation process according to the embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments will be described with reference to figures. In the description below, the same parts and components are denoted by the same reference characters. Their names and functions are also the same. Therefore, they will not be described repeatedly. First, terms used in the embodiments will be described.

The term “spot color” refers to a color having a special meaning for a user of a printed material, such as a logotype or a brand color that is a color representing a brand. The spot color is also referred to as “specific color”. The spot color is one example of a “designated color”, and the designated color is not limited to the spot color.

The term “colorimetry” refers to measurement of a color of an image printed by a printer on a medium such as a sheet. In a color verification process, the printer prints a color patch, and a colorimeter measures the color of the printed color patch.

The term “color verification” indicates a process of evaluating whether or not appropriate color reproducibility is realized by a printer. The color reproducibility means that even when images are formed (drawn or printed) on media (sheets or the like) by any printer, the formed images exhibit the same brightness or hue.

In the color verification, a colorimetry value is compared with a target value, and the color verification is performed based on a difference (hereinafter, referred to as “color difference”) therebetween obtained by the comparison. More specifically, in the color verification, each of the colorimetry value and the target value is indicated by a Lab value indicating coloration, for example. For example, in the color verification, when a color difference value quantitatively indicating a color difference, such as a difference in Lab value between the colorimetry value and the target value, does not exceed a permissible range, “Passed” (success) is output as a color verification result. When the color difference value exceeds the permissible range, “Failed” (failure) is output as the color verification result. It should be noted that the color value is not limited to the Lab value, and may be a Munsell value (HVC).

### A. Configuration

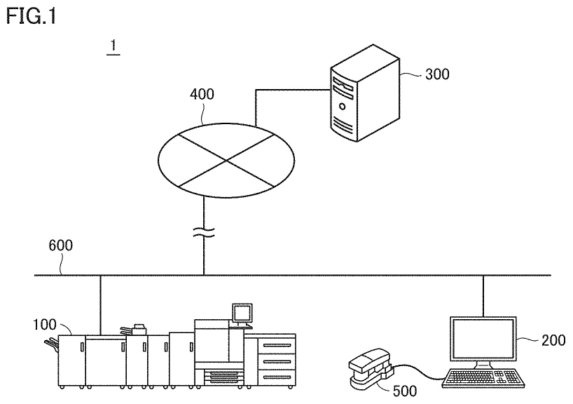

FIG. 1 is a configuration diagram of a system according to the present embodiment. Referring to FIG. 1, a system 1 includes: an image forming apparatus 100 installed in, for example, a printing company; and an information processing apparatus 200 to which a colorimeter 500 having a color sensor can be connected. Image forming apparatus 100, colorimeter 500, and information processing apparatus 200 communicate with one another via a network 600 in the printing company. System 1 further includes a server 300 connected to a network 400. Network 600 is connected to network 400 via a communication device (such as a router or a switch) not shown in the figure. Therefore, in system 1, image forming apparatus 100, colorimeter 500, information processing apparatus 200, and server 300 can communicate with one another via networks 400, 600.

It should be noted that colorimeter 500 may be connected to network 600 or may be included in image forming apparatus 100. Further, network 400 includes a network external to the printing company or a network internal to the company. Further, each of networks 400, 600 includes a wired or wireless network. Further, networks 400 and 600 are shown as different networks in FIG. 1, but may be the same network.

In the present embodiment, server 300 mainly performs color verification for image forming apparatus 100, but the apparatus for performing the color verification is not limited to server 300 and may be information processing apparatus 200. Further, when image forming apparatus 100 is configured to include a server or information processing apparatus therein, the server or information processing apparatus included therein may perform the color verification.

Typically, a general-purpose computer such as a personal computer is applied to information processing apparatus 200. Although information processing apparatus 200 is shown as a stationary type information processing apparatus in FIG. 1, information processing apparatus 200 may be a portable type information processing apparatus such as a tablet type or laptop type information processing apparatus.

(a1. Hardware Configuration of Image Forming Apparatus 100)

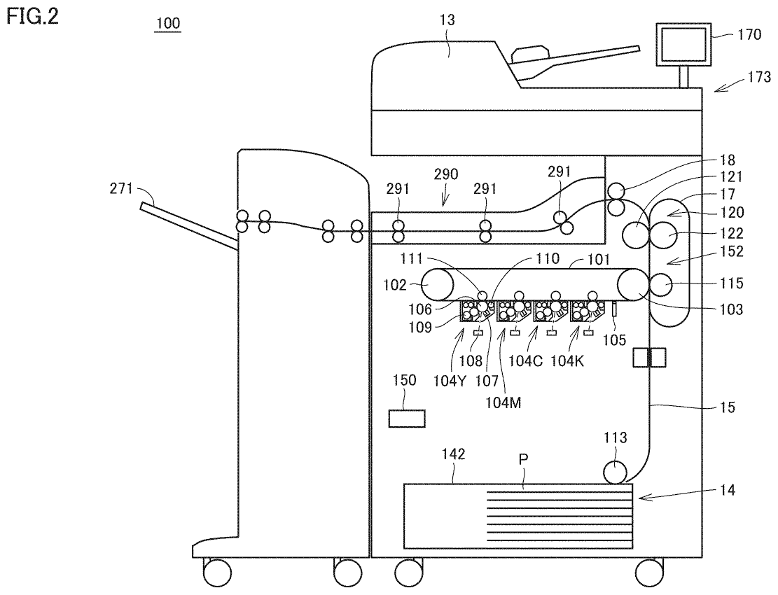

FIG. 2 is a schematic diagram showing an internal configuration of image forming apparatus 100. Image forming apparatus 100 is illustrated as a printer, a copy machine, or an MFP (Multi-Function Peripheral), which is a composite machine of the printer and the copy machine. Functions included in image forming apparatus 100 are not limited to those of the printer and the copy machine, and may further include functions such as those of a scanner and a facsimile. Image forming apparatus 100 can execute a print job, a copy job, a scan job, a facsimile job, and the like. It should be noted that image forming apparatus 100 may be provided as a printing apparatus that provides only the printer function.

Image forming apparatus 100 includes an image forming unit 152, an image scanning unit 173, an automatic document feeding unit 13, a sheet supplying unit 14, a conveyance path 15, a reverse conveyance path 17, an ejection roller 18, and an operation panel 170. Image forming apparatus 100 further includes a controller 150 that controls image forming apparatus 100.

Automatic document feeding unit 13 automatically feeds a document placed on a document table, to a scanning position of image scanning unit 173. Image scanning unit 173 optically scans an image of the document fed by automatic document feeding unit 13, and generates image data. Sheet supplying unit 14 includes a sheet supplying roller 113 and a sheet supplying cassette 142. Sheets P are accommodated in sheet supplying cassette 142. Sheet supplying roller 113 sends a sheet P upward along conveyance path 15. Reverse conveyance path 17 is used for double-side printing; however, reverse conveyance path 17 may be used for single-side printing.

Based on the image data generated by image scanning unit 173 or image data obtained from a print job, image forming unit 152 forms an image on sheet P supplied by sheet supplying unit 14. For example, image forming apparatus 100 can receive a print job from an external apparatus such as information processing apparatus 200 or server 300.

Image forming unit 152 has a so-called printer configuration. More specifically, image forming unit 152 includes an intermediate transfer belt 101, paper stop rollers 102, 103, a yellow image forming unit 104Y, a magenta image forming unit 104M, a cyan image forming unit 104C, a black image forming unit 104K, an image density sensor 105, primary transferring devices 111, a secondary transferring device 115, and a fixing device 120. Fixing device 120 includes a heating roller 121 and a pressing roller 122.

Intermediate transfer belt 101 is an endless belt member. Both end portions of intermediate transfer belt 101 are supported by paper stop rollers 102, 103. Image forming units 104Y, 104M, 104C, 104K for the respective colors and image density sensor 105 are disposed below intermediate transfer belt 101.

Image forming unit 104Y includes a photoconductor drum 106, a charging device 107, an exposure device 108, a developing device 109, and a cleaning device 110. Charging device 107, exposure device 108, developing device 109, and cleaning device 110 are disposed around photoconductor drum 106. It should be noted that each of image forming units 104M, 104C, 104K has the same hardware configuration as that of image forming unit 104Y.

Ejection roller 18 is disposed on the downstream side with respect to fixing device 120 in conveyance path 15. Sheet ejection roller 18 sends, to a horizontal conveyance unit 290, sheet P ejected from image forming units 104Y, 104M, 104C, 104K. A plurality of horizontal conveyance rollers 291 included in horizontal conveyance unit 290 convey sheet P ejected from ejection roller 18, to an external tray 271 attached to image forming apparatus 100.

Next, an operation of image forming apparatus 100 will be described. Image forming apparatus 100 generates respective pieces of image data for the colors in accordance with a document scanned by image scanning unit 173 or in accordance with a print job. The generated pieces of image data for the colors are sent to corresponding image forming units 104Y, 104M, 104C, 104K. Image forming units 104Y, 104M, 104C, 104K for the colors charges and exposes respective photoconductor drums 106 based on the respective pieces of image data, thereby forming electrostatic latent images. Further, image forming units 104Y, 104M, 104C, 104K develop the formed electrostatic latent images to form toner images.

The formed toner images are sequentially transferred to and overlaid on intermediate transfer belt 101 by respective primary transferring devices 111. At the same time, a sheet P is sent upward from sheet supplying unit 14 along conveyance path 15, and the toner images overlaid on intermediate transfer belt 101 are synchronously transferred to sheet P by secondary transferring device 115. Sheet P having the toner images thereon is further conveyed to fixing device 120, and is heated and pressed by fixing device 120. Thus, the toner images are fixed to sheet P. Sheet P having the toner images fixed thereon is ejected to horizontal conveyance unit 290 by ejection roller 18. In the case where colorimeter 500 is included in image forming apparatus 100, colorimeter 500 performs colorimetry by scanning sheet P before printed sheet P is ejected.

It should be noted that in the case of single-side printing, sheet P having the toner images fixed on its front surface by fixing device 120 is ejected without a further process of image forming. In the case of double-side printing, the sheet is conveyed again to secondary transferring device 115 via reverse conveyance path 17 to form an image on its rear surface, and is then ejected.

(a2. Module Configuration of Image Forming Apparatus 100)

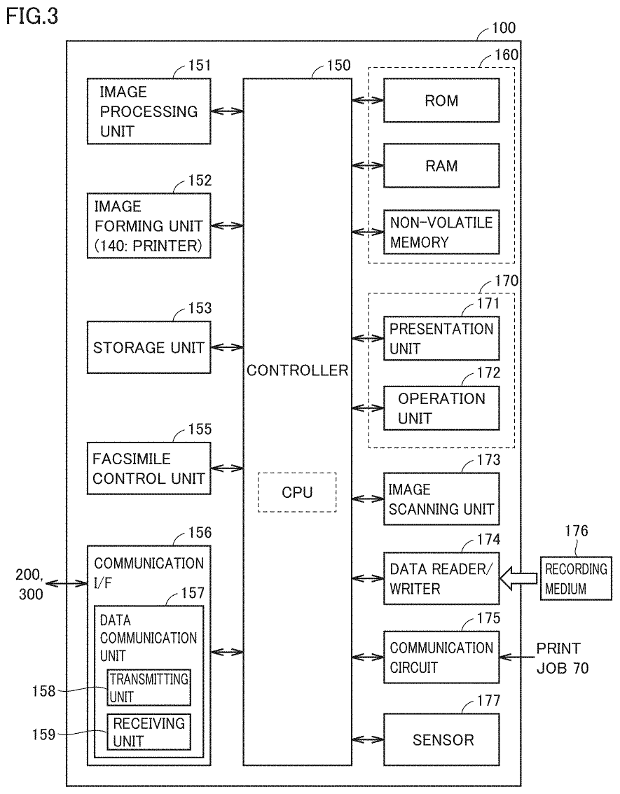

FIG. 3 is a diagram schematically showing an exemplary module configuration of image forming apparatus 100. Referring to FIG. 3, image forming apparatus 100 includes: a controller 150 including a CPU (Central Processing Unit) including a hardware processor circuitry; a storage unit 160 that stores a program and data; an operation panel 170; a communication I/F (interface) 156 that communicates with server 300 or information processing apparatus 200 via network 600; a communication circuit 175; various types of sensors 177; and various types of processing units.

Storage unit 160 includes a ROM (Read Only Memory), a RAM (Random Access Memory), a non-volatile memory, and the like, each of which stores a program to be executed by the CPU of controller 150 as well as data. The RAM is also provided as a work area when a program is executed by the CPU of controller 150.

Operation panel 170 includes: a presentation unit 171 including a display; and an operation unit 172 that is operated by a user to input information to image forming apparatus 100. Here, operation panel 170 may be provided as a touch panel in which presentation unit 171 and operation unit 172 are formed in one piece.

Communication I/F 156 includes a circuit such as a NIC (Network Interface Card). Communication I/F 156 includes a data communication unit 157 that conforms to a communication standard such as Wi-Fi (registered trademark). Data communication unit 157 includes: a transmitting unit 158 that transmits data to external apparatuses including server 300 and information processing apparatus 200 via the networks; and a receiving unit 159 that receives data from the external apparatuses including server 300 and information processing apparatus 200 via the networks. Communication circuit 175 can include a communication circuit that conforms to a communication standard such as NFC (Near Field Communication) or USB (Universal Serial Bus). Each of communication I/F 156 and communication circuit 175 receives a print job 70.

The various types of processing units described above include: an image processing unit 151 that generates image data of each color based on document data scanned from a document or print job 70; an image forming unit 152; a storage unit 153, such as a hard disk, that stores various types of data including image data; a facsimile control unit 155 that controls a facsimile circuit (not shown); an image scanning unit 173; and a data reader/writer 174 to which a recording medium 176 is detachably attached.

Data reader/writer 174 has: a circuit that reads out a program or data from recording medium 176 attached thereto; and a circuit that writes data to recording medium 176.

Image processing unit 151 generates image data of each color from print job 70. More specifically, print job 70 includes PJL data, PDL (page description language) data, and a user ID that identifies a user having provided print job 70. The PJL data is an instruction that does not directly affect the PDL data, and includes commands for functions such as stapling and punching. Image processing unit 151 loads the PDL data of print job 70 as bitmap data on the RAM of storage unit 160. In accordance with the bitmap data (PDL data) loaded by image processing unit 151, image forming unit 152 performs a printing process for each color onto sheet P. Also, image processing unit 151 loads, as bitmap data, image data scanned from a document by image scanning unit 173. In accordance with the bitmap data loaded with regard to the document, image forming unit 152 performs a printing process for each color on sheet P.

(a3. Hardware Configuration of Server 300)

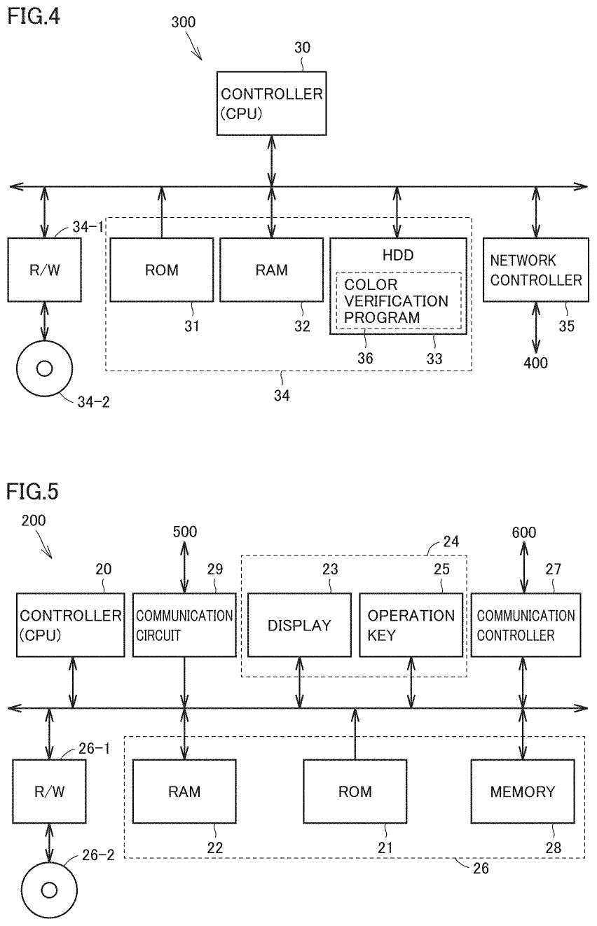

FIG. 4 is a diagram schematically showing an exemplary hardware configuration of server 300. Referring to FIG. 4, server 300 includes: a controller 30 including a CPU including a hardware processor circuitry; a storage unit 34; and a network controller 35. Further, server 300 includes an R/W (abbreviation of “reader/writer”) 34-1. A recording medium 34-2 is detachably attached to R/W 34-1. R/W 34-1 reads and writes data and a program from and into attached recording medium 34-2 under control of controller 30.

Storage unit 34 includes a ROM 31, a RAM 32, and a hard disk drive (HDD) 33, each of which stores a program to be executed by the CPU of controller 30 and data. RAM 32 includes: an area that stores various types of information; and a work area when a program is executed by the CPU of controller 30. HDD 33 stores a color verification program 36. Network controller 35 includes a circuit, such as a NIC, that controls communication between server 300 and another apparatus via network 400.

(a4. Hardware Configuration of Information Processing Apparatus 200)

FIG. 5 is a diagram schematically showing an exemplary hardware configuration of information processing apparatus 200. Referring to FIG. 5, information processing apparatus 200 includes: a controller 20 including a CPU including a hardware processor circuitry; a display 23; an operation key 25 that is operated by a user to input information to information processing apparatus 200; a storage unit 26; a communication controller 27; and a communication circuit 29. Further, information processing apparatus 200 includes an R/W (abbreviation of “reader/writer”) 26-1. A recording medium 26-2 is detachably attached to R/W 26-1. R/W 26-1 reads and writes data and a program from and into attached recording medium 26-2 under control of controller 20. Storage unit 26 includes a ROM 21, a RAM 22, and a memory 28, each of which stores a program to be executed by CPU 20 and data. Memory 28 includes a hard disk device. Display 23 and operation key 25 may be provided as an operation panel 24 such as a touch panel in which display 23 and operation key 25 are formed in one piece. Communication controller 27 includes a communication circuit, such as an NIC or a LAN circuit, that controls communication between information processing apparatus 200 and another apparatus via network 600. Communication circuit 29 communicates with colorimeter 500 in accordance with a communication standard such as USB.

### B. Configuration for Implementing Color Verification System

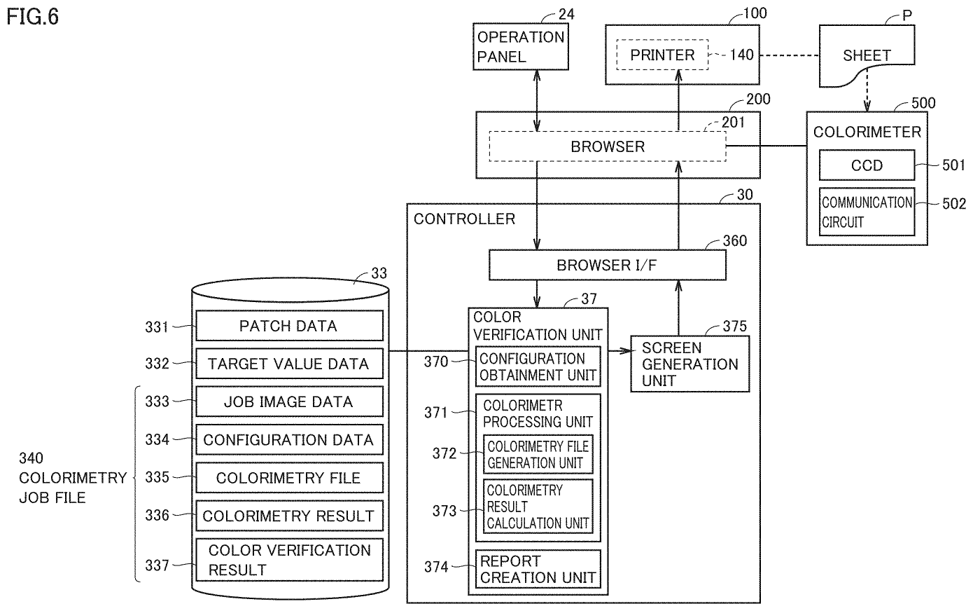

FIG. 6 is a diagram schematically showing a module configuration of a color verification system according to the present embodiment. Referring to FIG. 6, controller 30 of server 300 implements a color verification unit 37 by executing a color verification program 36. The color verification system is implemented when information processing apparatus 200 uses a browser 201 included in information processing apparatus 200 to exchange data with server 300 serving as a web server, more specifically, exchange data with color verification unit 37. Here, browser 201 is included in information processing apparatus 200; however, browser 201 may be included in image forming apparatus 100. An environment provided by color verification unit 37 is not limited to server 300, and may be implemented in information processing apparatus 200 or image forming apparatus 100. Hence, when each of server 300, information processing apparatus 200, and image forming apparatus 100 has the modules included in controller 30 and the data (including the data stored in HDD 33) in FIG. 6, each of server 300, information processing apparatus 200, and image forming apparatus 100 constitutes one embodiment of the “color verification apparatus”.

The data stored in HDD 33 includes: patch data 331 indicating a patch of each spot color; target value data 332 representing a target Lab value for each spot color; and a colorimetry job file 340. Colorimetry job file 340 is generated and stored whenever a color verification job is executed in server 300. A job identifier is assigned to colorimetry job file 340 in order to identify the file.

Colorimetry job file 340 includes job image data 333, configuration data 334, a colorimetry file 335, a colorimetry result 336, and a color verification result 337. Job image data 333 indicates an image to be subjected to color verification, and includes an image that is based on image data obtained from print job 70, for example Configuration data 334 includes data indicating one or more designated positions on the image indicated by job image data 333, the one or more designated positions being one or more positions at which each of one or more specific colors designated for printing of the image is to be printed. Colorimetry file 335 corresponds to a printing file for causing printer 140 to print a patch of each of the one or more designated colors on a sheet P at a position corresponding to each of the one or more designated positions for the designated color. Colorimetry file 335 (printing file) can be converted into print job 70 by performing a predetermined process. Colorimetry result 336 includes a colorimetry value on printed sheet P at a position corresponding to each of the one or more designated positions. Color verification result 337 includes a result of color verification that is based on the colorimetry value on printed sheet P at the position corresponding to each of the one or more designated positions and a target value indicated by color target value data 332 and corresponding to the designated position.

Controller 30 includes: a browser I/F (abbreviation for “interface”) 360 that communicates with browser 201 of information processing apparatus 200 to exchange data; a color verification unit 37; and a screen generation unit 375. Screen generation unit 375 generates a screen (screen data) that can be presented by browser 201 in accordance with an output from color verification unit 37. The generated screen is transmitted to browser 201 via browser I/F 360. Browser 201 causes display 23 of operation panel 24 to present the screen received from server 300. Screen generation unit 375 can generate screen data using, for example, HyperText Markup Language (HTML) for web page screens.

Color verification unit 37 includes: a configuration obtainment unit 370 that obtains configuration data 334; a colorimetry processing unit 371; and a report creation unit 374 that creates a report of a result of color verification. Colorimetry processing unit 371 includes: a colorimetry file generation unit 372 that generates colorimetry file 335; and a colorimetry result calculation unit 373 that calculates colorimetry result 336. Configuration obtainment unit 370 is one embodiment of a “color position obtainment module” configured by executing color verification program 36 by the CPU of controller 30. Colorimetry file generation unit 372 is one embodiment of “file generation module” configured by executing color verification program 36 by the CPU of controller 30. Report creation unit 374 is one embodiment of a “report module” that outputs a result of color verification and that is configured by executing color verification program 36 by the CPU of controller 30.

Referring to FIG. 6, colorimeter 500 optically scans the image printed on sheet P using a CCD (Charge Coupled Device) 501, generates, from an output of CCD 501, a colorimetry value that is based on a value corresponding to a coloration of each pixel at a scanning position, and transmits the generated colorimetry value to information processing apparatus 200 via communication circuit 502.

### C. Process and Exemplary Presentation Screen

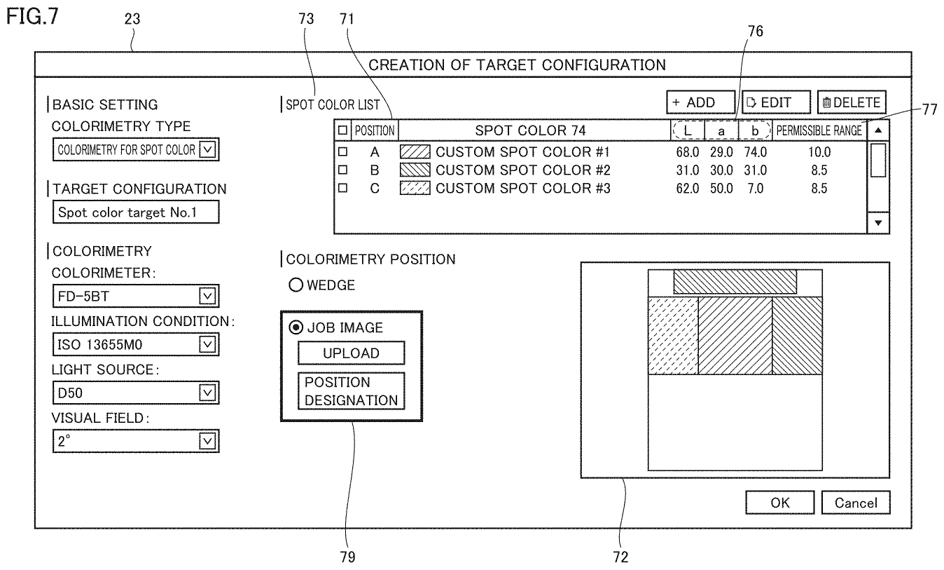

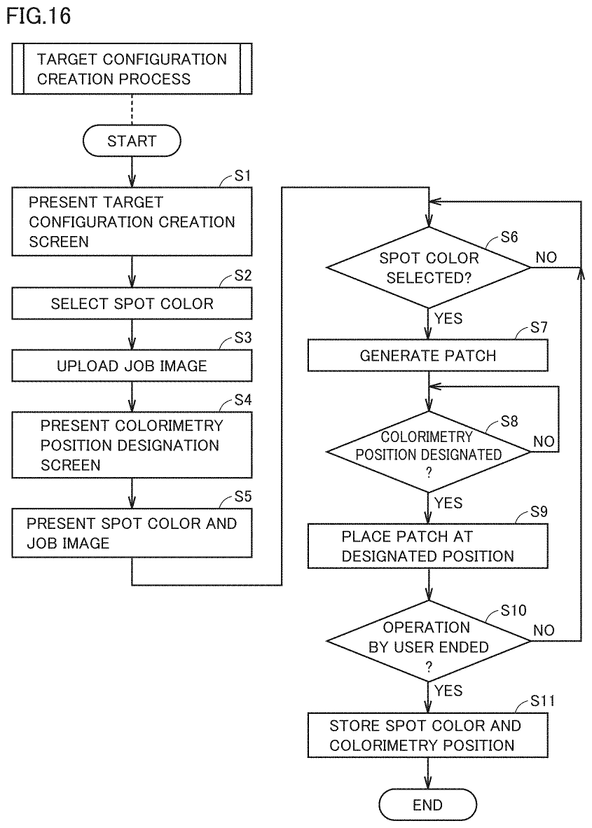

By operating operation panel 24, the user can perform color verification in a manner interactive with color verification unit 37 of server 300 via a screen presented on display 23 by browser 201. Such a process regarding the interactive manner is implemented by controller 20 of information processing apparatus 200 operating as browser 201, and controller 30 of server 300 operating as browser I/F 201, color verification unit 37, and screen generation unit 375. Hereinafter, a color verification process for a spot color will be described; however, the target for the color verification is not limited to the spot color, and another color may be the target for the verification. Each of FIGS. 7 to 9 and 13 to 15 is a diagram showing an exemplary browser screen presented by browser 201. Each of FIGS. 16 to 20 is a flowchart of a process according to the embodiment of the present invention. Referring to FIGS. 7 to 15, the processes of the color verification system will be described in accordance with the flowcharts of FIGS. 16 to 20.

(c1. Target Configuration Creation Process)

Referring to FIG. 16, the following describes creation of target configuration data 334 (hereinafter, also referred to as target configuration). Controller 30 operates as configuration obtainment unit 370 to perform the process of FIG. 16. First, controller 30 transmits screen data for a target configuration creation screen to information processing apparatus 200. Browser 201 causes display 23 to present a screen (FIG. 7) that is based on the received screen data (step S1).

The screen (FIG. 7) includes a spot color list 73, a radio button 79, and a window 72 that presents an image corresponding to an uploaded image. Spot color list 73 shows a list of spot colors that have been registered in advance and that are used to print a target image of the target. More specifically, spot color list 73 includes: a position identifier 71 that identifies a position corresponding to each of one or more spot colors in an image, each of the one or more spot colors being a candidate for colorimetry; a target value 76 for the spot color, target value 76 being indicated by a Lab value; and a permissible range 77 for color difference value. Position identifier 71 identifies a position, in the target image, at which a corresponding spot color is to be printed. Permissible range 77 is a type of threshold value. Permissible range 77 may be a range of values, or may be a single value. The user can set permissible range 77 by an operation via operation panel 24.

From spot color list 73, the user selects spot color(s) 74 intended to be subjected to the colorimetry (step S2). On this occasion, the user can also set permissible range 77 for each of the selected spot color(s). Further, the user operates an upload button of radio button 79 to upload a job image of an image to be printed using selected spot color(s) 74 (step S3). For example, image data obtained from print job 70 is presented in window 72 of the screen (FIG. 7).

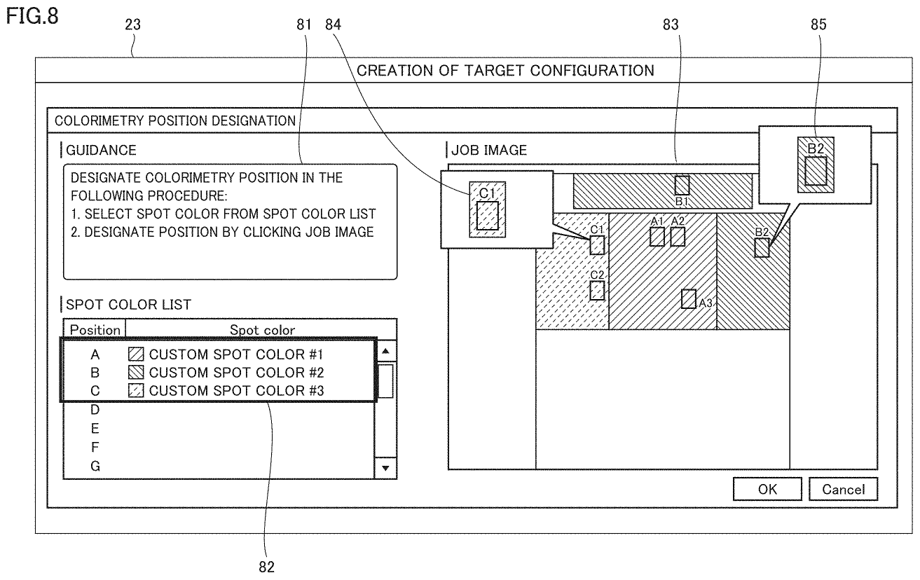

When the user operates a position designation button of radio button 79, controller 30 transmits data of a screen for designating colorimetry positions. Based on the received screen data, browser 201 causes display 23 to present a screen (FIG. 8) for designating the colorimetry positions (step S4).

The screen (FIG. 8) for designating the colorimetry positions is a screen for designating: one or more spot colors used (designated) by the user to print the image; and one or more positions on the image at which each of the spot colors is to be printed. More specifically, the screen (FIG. 8) has: a guidance 81 including a message for supporting a designation operation; a list 82 of the spot colors selected by the user in the screen (FIG. 7) for the target configuration creation; and a window 83 that presents the image of job image data 333 (step S5). In accordance with guidance 81, the user performs an operation of: selectively designating the spot colors; and designating positions (colorimetry positions) to be subjected to the colorimetry for each of the spot colors.

Based on the user operation received on the screen (FIG. 8), controller 30 places patches 84, 85 of the spot colors on the image of window 83 at the positions to be subjected to the colorimetry (steps S6 to S100). More specifically, in accordance with the user operation received via the screen (FIG. 8), controller 30 determines whether or not the user has selected a spot color from spot color list 82 (step S6). While it is determined that the user has selected no spot color (NO in step S6), controller 30 repeats the determination of step S6. When controller 30 determines that the user has selected a spot color (YES in step S6), controller 30 generates a color patch for the selected spot color based on patch data 331 (step S7). Further, in accordance with the user operation received via the screen (FIG. 8), controller 30 determines whether or not the user has designated a position on the image of window 83 (step S8). While it is determined that no position has been designated (NO in step S8), controller 30 repeats the determination of step S8. On the other hand, when it is determined that the user has designated a position (YES in step S8), the patch generated in step S7 is placed on the image of window 83 at the position designated by the user (step S9). More specifically, controller 30 causes display 23 to present the image, and obtains, as the designated position, the position designated by the operation of the user on the presented image. That is, controller 30 generates screen data in which the patch for the selected spot color is placed at the designated position on the image of window 83, and transmits the screen data to information processing apparatus 200. Browser 201 causes display 23 to present a screen that is based on the screen data received from controller 30. Thus, the image of window 83 of the screen (FIG. 8) presented on display 23 is updated to draw the patch of the spot color selected by the user at the position designated by the user. In accordance with the user operation, controller 30 determines whether or not the position designation operation has been ended (step S10). When controller 30 does not determine that the operation has not been ended (NO in step S10), the process returns to step S6. A colorimetry position is designated for the next spot color. When controller 30 determines that the operation has been ended (YES in step S10), controller 30 generates configuration data 334 and stores configuration data 334 into HDD 33 (step S11). For each of the one or more spot colors selected by the user, configuration data 334 includes: the one or more colorimetry positions designated by the user on the job image of window 83 of the screen (FIG. 8); respective identifiers for the colorimetry positions; and target values 76. The one or more colorimetry positions, the identifiers, and target values 76 are included in configuration data 334 in association with one another.

In the screen (FIG. 8), for example, three colorimetry positions are designated for a “custom spot color 1” by the user. At the three colorimetry positions, respective identifiers A1, A2, A3 for the colorimetry positions are drawn in the vicinity of the patches. Further, two colorimetry positions are designated for a “custom spot color 2” by the user. At the two colorimetry positions, respective identifiers B1, B2 for the colorimetry positions are drawn in the vicinity of the patches. For a “custom spot color 3”, the user designates two colorimetry positions. At the colorimetry positions, identifiers C1, C2 for the colorimetry positions are drawn in the vicinity of the patches. Here, each of the identifiers for the colorimetry positions for the spot colors is indicated using a combination of a symbol that identifies a corresponding spot color (symbol A, B, C, or the like) and a symbol that identifies a corresponding colorimetry position (numerical value 1, 2, 3, or the like). It should be noted that the expression of the identifier is not limited to this as long as the colorimetry position for the spot color can be identified.

(c2. Calorimetry Process)

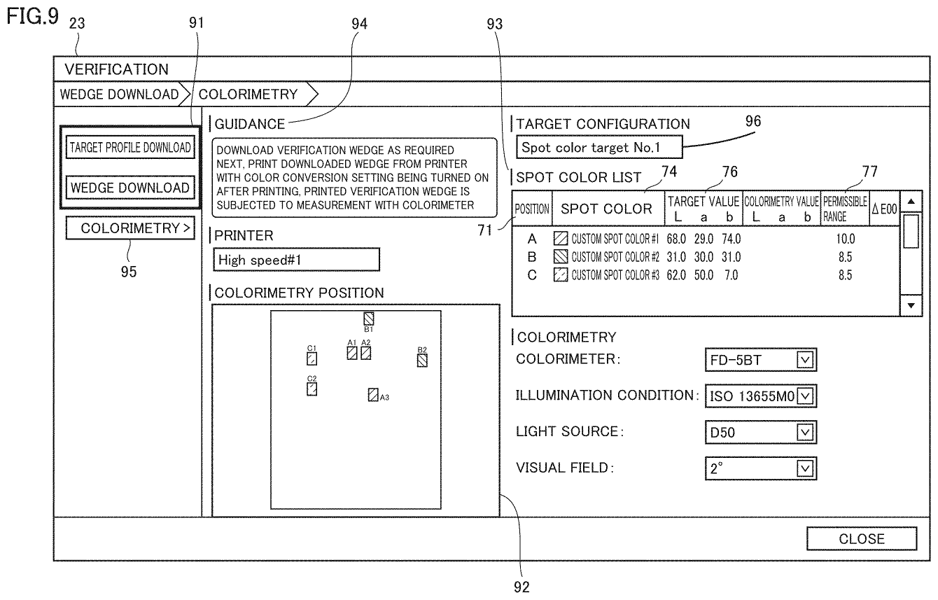

In the colorimetry process, the user performs a user operation to perform the colorimetry process via a browser screen (FIGS. 9 and 13 to 15) presented by browser 201. Here, HDD 33 of server 300 stores a plurality of pieces of configuration data 334.

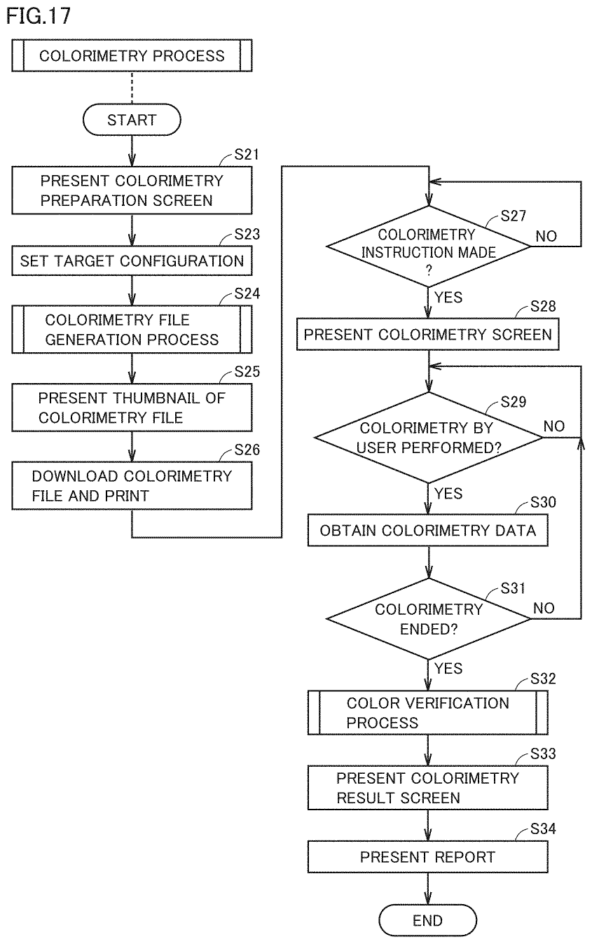

The following describes the colorimetry process in accordance with the flowchart of FIG. 17. First, the user selects one piece of configuration data 334 from the plurality of pieces of configuration data 334 and inputs a colorimetry instruction. Controller 30 receives this user operation, and generates, based on configuration data 334 selected from the plurality of pieces of configuration data 334 of HDD 33, screen data for a screen (FIG. 9) for preparing for the colorimetry. Controller 30 transmits the generated screen data to information processing apparatus 200, and browser 201 causes display 23 to present the screen (FIG. 9) that is based on the received screen data (step S21).

The screen (FIG. 9) includes: a radio button 91; a window 92; a spot color list 93; a guidance 94 having a message for supporting the preparation for colorimetry; a button 95 for instructing to start the colorimetry; and an identifier 96 for configuration data 334. In spot color list 93, data set in a below-described step S23 is presented. Further, window 92 presents an image of colorimetry file 335 generated in a process of a below-described step S24. As the image of window 92, there is presented an image of colorimetry file 335 that is based on configuration data 334 selected by the user, such as a thumbnail corresponding to the size of window 92.

When the user operates a “target profile download” button of radio button 91, browser 201 requests controller 30 for configuration data 334 selected by the user. Based on the request from browser 201, controller 30 searches HDD 33 for configuration data 334 selected by the user, and transmits configuration data 334 to browser 201.

Browser 201 sets, to spot color list 93 of the screen (FIG. 9), configuration data 334 received from server 300 (step S23). More specifically, the information set by the user in spot color list 73 of the target configuration creation screen (FIG. 7) is set to spot color list 93.

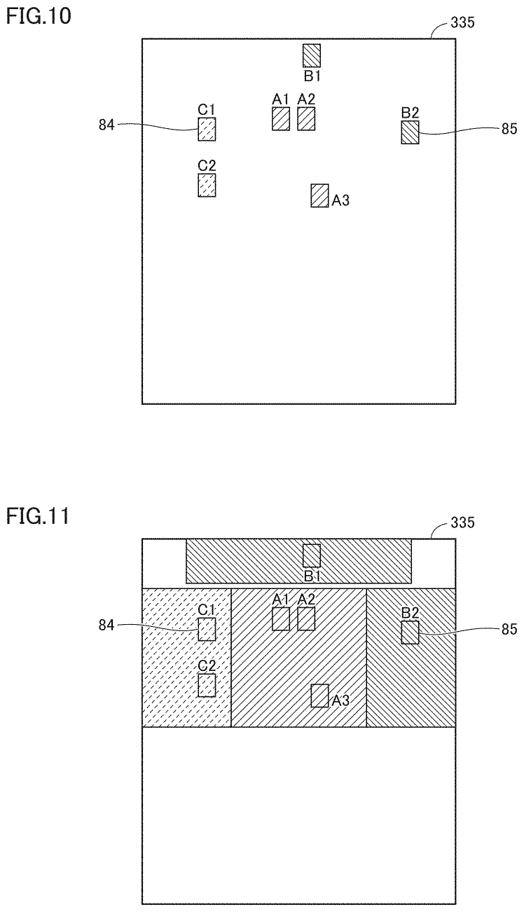

A colorimetry file generation process (step S24) is performed. More specifically, in accordance with the user operation received via the browser screen, controller 30 generates colorimetry file 335 that is a printing file for causing printer 140 to perform printing, stores colorimetry file 335 into HDD 33, and transmits colorimetry file 335 to browser 201. Details of the colorimetry file generation process will be described later with reference to FIGS. 10 to 12 and 18.

In window 92, browser 201 presents, as a thumbnail, an image that is based on colorimetry file 335 received from controller 30 (step S25). In the image that is based on colorimetry file 335 in window 92, the patches of spot colors 74 designated by the user in spot color list 93 are placed at the colorimetry positions designated by the user (positions indicated by identifiers A1, A2, A3, B1, B2, C1, C2).

When the user operates a “wedge download” button of radio button 91, downloading of colorimetry file 335 and printing in accordance with colorimetry file 335 are performed (step S26). More specifically, in accordance with the user operation on the “wedge download” button, browser 201 requests controller 30 for colorimetry file 335 corresponding to the image presented in window 92. Based on the request from browser 201, controller 30 searches HDD 33 for colorimetry file 335, and downloads colorimetry file 335 to information processing apparatus 200. Information processing apparatus 200 converts downloaded colorimetry file 335 into a print job and transmits the print job to image forming apparatus 100. Image forming apparatus 100 executes the print job of colorimetry file 335 received from information processing apparatus 200. Thus, printer 140 prints the image on sheet P in accordance with colorimetry file 335, and outputs printed sheet P to tray 271.

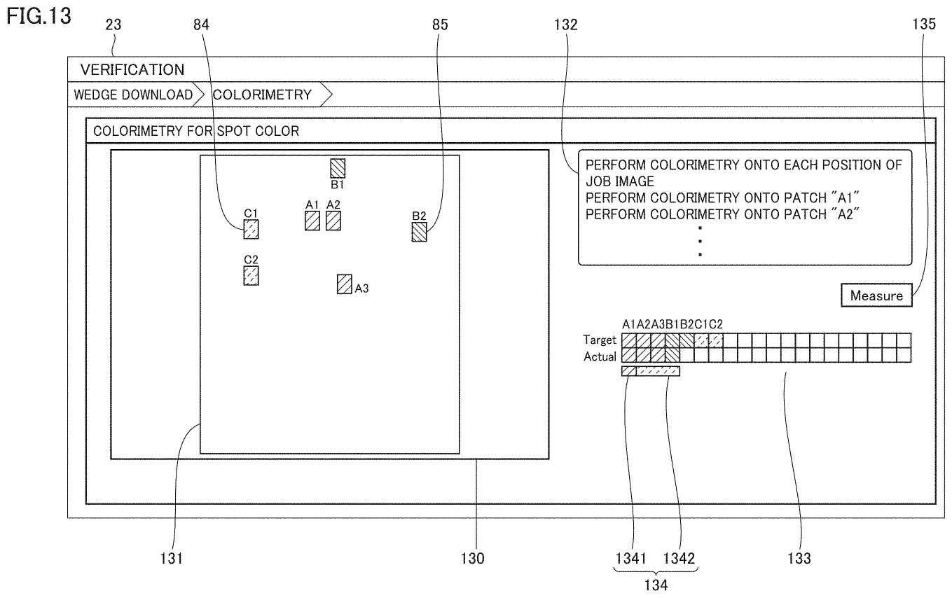

Controller 30 stands by until an operation for colorimetry instruction is received from the user (NO in step S27). When the colorimetry instruction is received from the user by operating button 95 (YES in step S27), browser 201 causes display 23 to present the colorimetry screen (FIG. 13) that is based on the screen data from controller 30 (step S28).

The colorimetry screen (FIG. 13) includes: a window 130 for presenting an image 131 of colorimetry file 335 in the form of, for example, a thumbnail; a guidance 132 including a message for colorimetry operation guidance to support the user; a colorimetry result 133; and a button 135 to be operated to instruct start and end of the colorimetry.

In image 131 of colorimetry file 335 of window 130, the patches (such as patches 84, 85) of the spot colors designated by the user are placed at the colorimetry positions designated by the user, and marks representing the identifiers for the colorimetry positions are drawn to correspond to the respective patches. More specifically, marks representing identifiers A1, A2, A3 for the colorimetry positions are drawn in the vicinity of the patches of custom spot color 1, marks representing identifiers B1, B2 for the colorimetry positions are drawn in the vicinity of the patches of custom spot color 2, and marks representing identifiers C1, C2 for the colorimetry positions are drawn in the vicinity of the patches of custom spot color 3. Each of these marks includes, for example, a letter/character.

The user operates colorimeter 500 to perform the colorimetry (steps S29 to S31). More specifically, controller 30 determines whether or not start of the colorimetry has been instructed by the user operation on button 135 (step S29). The user performs the colorimetry onto the colorimetry positions (i.e., patches) on printed sheet P. Guidance 132 includes a message that instructs the user to perform the colorimetry onto the colorimetry positions in accordance with a predetermined order. For example, guidance 132 includes a message that instructs the user to perform the colorimetry onto the colorimetry positions in a predetermined order. For example, guidance 132 includes a message instructing the user to perform the colorimetry onto the colorimetry positions in the following order: the colorimetry positions of custom spot color 1 (order of identifiers A1→A2→A3)→the colorimetry positions of custom spot color 2 (order of identifiers B1→B2)→the colorimetry positions of custom spot color 3 (order of identifiers C1→C2). By checking the colorimetry positions indicated by the marks provided for the patches in image 131 of window 130 against the colorimetry positions indicated by the message, the user can specify the order of the colorimetry positions indicated by the message as the order of performing the colorimetry onto the patches printed on sheet P. Further, in order to readily specify the order of performing the colorimetry onto the patches on sheet P, the marks of the identifiers for the colorimetry positions may be printed on printing sheet P at positions that are consistent with the drawn positions of the marks of the identifiers in image 131. More specifically, colorimetry file 335 may include a colorimetry file that allows a mark of an identifier for each colorimetry position to be printed on sheet P at a position associated with the colorimetry position (patch) (for example, in proximity to the patch).

By following such a guidance 132, the user operates colorimeter 500 to perform the colorimetry onto sheet P at the positions corresponding to the designated positions of the spot colors. Colorimeter 500 outputs a colorimetry value for each colorimetry position.

It should be noted that when colorimeter 500 is included in image forming apparatus 100, colorimeter 500 scans the identifier in the vicinity of each patch on sheet P (in proximity to the patch) using an OCR (optical character recognition) function. While colorimeter 500 specifies the colorimetry positions and colorimetry order indicated by the message of guidance 132 on sheet P based on the scanning result, colorimeter 500 performs the colorimetry onto the specified colorimetry positions in accordance with the specified order.

When controller 30 determines that button 135 has not been operated (NO in step S29), controller 30 repeats step S29. When it is determined that button 135 has been operated (YES in step S29), controller 30 receives colorimetry data indicating a colorimetry value via information processing apparatus 200 (step S30). The colorimetry data represents a result of colorimetry performed using colorimeter 500 by the user in accordance with guidance 132, and represents, for example, a set in which the colorimetry values at the respective colorimetry positions indicated by identifiers A1, A2, A3, B1, B2, C1, C2 are arranged in the order of the colorimetry positions.

Controller 30 determines whether or not end of the colorimetry has been instructed in accordance with the user operation on button 135 (step S31). When it is determined that end of the colorimetry has not been instructed (NO in step S31), the process returns to step S29 and controller 30 determines whether or not button 135 has been operated to start colorimetry for the next spot color (step S29).

In step S30, in colorimetry result 133 of the colorimetry screen (FIG. 13), controller 30 presents an actual color (Actual) and a target color (Target) in association with a corresponding colorimetry position in such a manner that the actual color (Actual) can be compared with the target color (Target). The actual color (Actual) is based on the Lab value that is the colorimetry value. The target color (Target) is based on the Lab value of target value 76 at the colorimetry position. Colorimetry result 133 may be presented in real time in parallel with the colorimetry operation performed using colorimeter 500 by the user at each colorimetry position.

Controller 30 generates a colorimetry result 336 having the colorimetry values (Actual) at the colorimetry positions with identifiers A1, A2, A3, B1, B2, C1, C2 and the target values (Target) for the spot colors at the colorimetry positions with identifiers A1, A2, A3, B1, B2, C1, C2 in association with the colorimetry positions with identifiers A1, A2, A3, B1, B2, C1, C2. Controller 30 stores colorimetry result 336 into HDD 33.

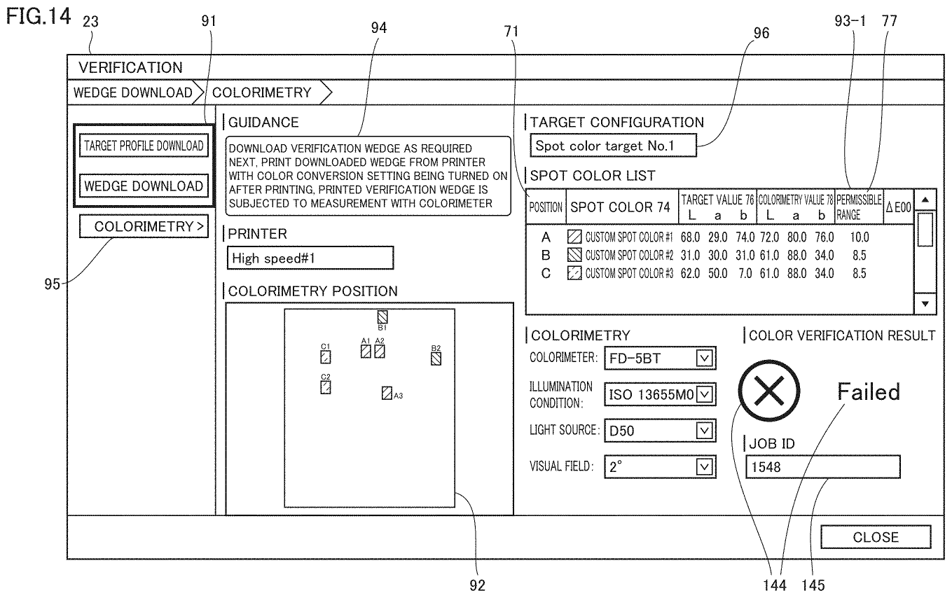

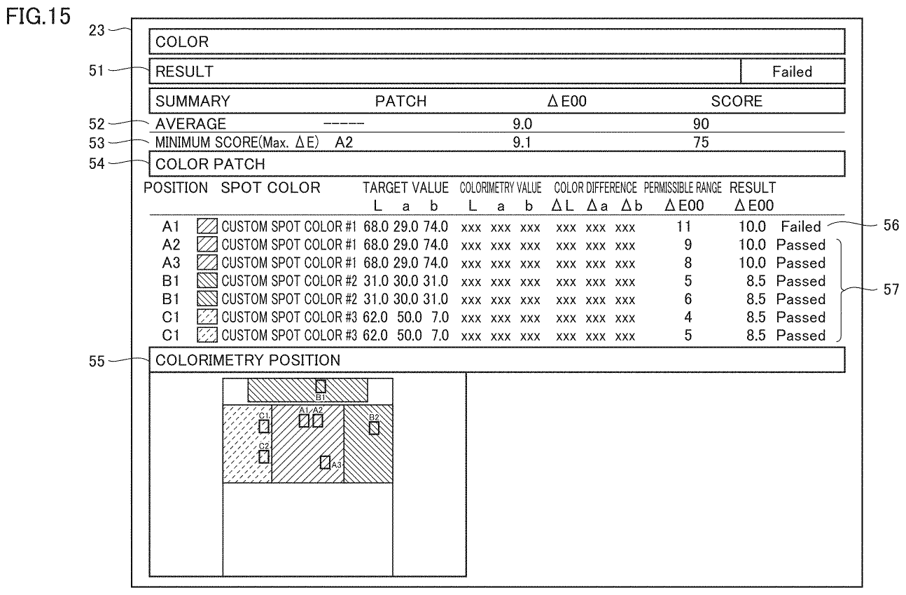

When controller 30 determines that end of the colorimetry has been instructed (YES in step S31), controller 30 performs a color verification process (step S32) using colorimetry result 336. Details of the color verification process (step S32) will be described later. Further, controller 30 stores, into HDD 33, color verification result 337 obtained through the color verification process. Controller 30 generates screen data for presenting color verification result 337. Controller 30 transmits the generated screen data to information processing apparatus 200, and browser 201 causes display 23 to present a screen (FIG. 14) that presents the colorimetry result that is based on the received screen data (step S33).

The screen (FIG. 14) has a mark 144 and a text box 145 in addition to the items shown in the screen (FIG. 9). Mark 144 represents a comprehensive verification result of the color verification result. Text box 145 is a text box for inputting an identifier of colorimetry job file 340. Further, in the screen (FIG. 14), a spot color list 93-1 is presented instead of spot color list 93 in FIG. 9. In addition to the items included in spot color list 93, spot color list 93-1 has an actual colorimetry value 78 at the colorimetry position for each spot color. Actual colorimetry value 78 indicates a representative value (for example, an average value, maximum value, minimum value, mode value, median value, or the like) of the actual colorimetry values at the one or more colorimetry positions for the corresponding spot color.

In the color verification process, for each spot color, it is determined whether or not a color difference exceeds the permissible range using target value 76, colorimetry value 78, and permissible range 77. In the screen (FIG. 14), mark 144 indicates a color verification result that is based on a determination result for each spot color. FIG. 14 shows a case where the color verification result represents “Failed” (Failure). For example, the case where mark 144 indicates “Failed” may include: a case where color verification results for one or more spot colors represent “Failed”; or a case where color verification results for all the spot colors represent “Failed”.

Returning to the colorimetry screen of FIG. 13, controller 30 may present color verification result 337 as an image 134 in colorimetry result 133 of the screen (FIG. 13). Image 134 has bar-shaped pictograms corresponding to the colorimetry positions. The pictograms are presented, for example, in the following manner: a green pictogram 1342 is presented when a color verification result at a corresponding colorimetry position indicates “Passed”; and a red pictogram 1341 is presented when a color verification result at a corresponding colorimetry position indicates “Failed”. Although the manner of presenting a pictogram is switched in accordance with a color verification result, the switching of the manner of presenting a pictogram is not limited to the switching between colors.

It should be noted that the presentation of the color verification results at the colorimetry positions, i.e., the presentation of pictograms 1341, 1342 may be performed in real time in parallel with the user operation of performing the colorimetry at the colorimetry positions using colorimeter 500.

Controller 30 outputs a colorimetry report (step S34). More specifically, in order to check the colorimetry report, the user inputs the identifier of colorimetry job file 340 into text box 145 (FIG. 14). When controller 30 receives a request for the colorimetry report from browser 201 together with the identifier of colorimetry job file 340 received by the user operation in text box 145, controller 30 searches HDD 33 for colorimetry job file 340 based on the identifier, generates screen data of a report screen (FIG. 15) based on searched colorimetry job file 340, and transmits the screen data to browser 201. Browser 201 causes display 23 to present a report screen (FIG. 15) that is based on the screen data of the report screen received from server 300.

(c3. Presentation of Report Screen)

The report screen (FIG. 15) includes items 51 to 57. Item 55 shows an image of job image data 333 representing the designated colorimetry positions (colorimetry positions indicated by identifiers A1, A2, A3, B1, B2, C1, C2). Item 54 indicates a target value, a colorimetry value, a color difference, a permissible range, and a color verification result (Passed or Failed) for each spot color designated by the user in association with a corresponding colorimetry position designated by the user. Item 51 indicates the same verification result as that of mark 144 of the comprehensive verification result. Items 52 and 53 indicate, for example, average and minimum values as representative values of color differences at all the colorimetry positions. In item 54, the color verification results each indicating “Passed” may be presented by item 57 in the green color, and the color verification result indicating “Failed” may be presented by item 56 in the red color.

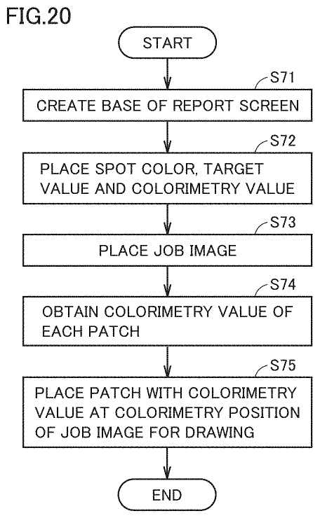

The following describes a process of generating the screen data of the report screen (FIG. 15) by controller 30 in accordance with the flowchart of FIG. 20. Controller 30 creates base data of the report screen (step S71), places, as item 54 in the base data, a target value and a colorimetry value for each specific color in association with a corresponding colorimetry position (step S72), and places the image of job image data 333 as item 55 (step S73). From colorimetry result 336, controller 30 obtains the colorimetry values obtained by colorimeter 500 at the colorimetry positions obtained from configuration data 334 (step S74). Controller 30 places the identifiers and patches for the colorimetry positions on the job image of item 55 for the sake of drawing (step S75). Thus, the report screen data is generated. Controller 30 transmits the generated screen data to information processing apparatus 200, and browser 201 causes display 23 to present the report screen (FIG. 15) that is based on the received screen data.

On the screen of item 55, report creation unit 374 may present the image that is based on image data 333 and may present a colorimetry value obtained at a position corresponding to each of one or more designated positions designated by the user operation on the image. Further, the colorimetry value may be presented in the form of a numerical value or the like, or may be presented in the form of a color patch indicating a coloration corresponding to the colorimetry value.

(c4. Process of Generating Colorimetry File 335)

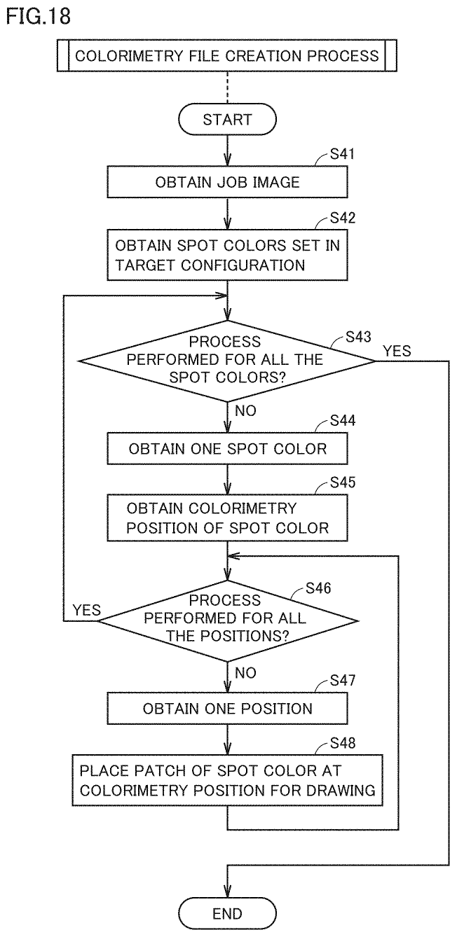

The following describes a process of generating colorimetry file 335 in accordance with the flowchart of FIG. 18. Controller 30 obtains job image data 333 from HDD 33 by searching for job image data 333 (step S41), and obtains, from configuration data 334, information of one or more spot colors designated by the user (step S42).

Controller 30 obtains one or more colorimetry positions for each spot color from configuration data 334. The one or more colorimetry positions are designated by the user and each spot color is designated by the user. For the sake of drawing, controller 30 places the patches of the spot color on the image indicated by job image data 333 at the colorimetry positions designated by the user, the patches being based on patch data 331 (steps S43, S44, S45, S46, S47, S48). For example, the patches are placed for the sake of drawing such that the patches overlap with the original image indicated by job image data 333 (step S48). More specifically, controller 30 determines whether or not the patches of all the spot colors designated by the user have been completely placed at all the colorimetry positions designated by the user (step S43). When controller 30 determines that the patches have been completely placed at all colorimetry positions (YES in step S43), the process is ended. When the end is not determined (NO in step S43), controller 30 obtains a spot color based on the user operation (step S44), obtains colorimetry positions for the obtained spot color (step S45), and places the patches of the spot color at the colorimetry positions, repeatedly (steps S44 to S48). Further, when it is not determined that patches of one spot color have been completely placed at the colorimetry positions (NO in step S46), the placement of the patches of the one spot color is repeated (steps S47, S48). However, when it is determined that the patches of the one spot color have been completely placed (YES in step S46), the process returns to step S43.

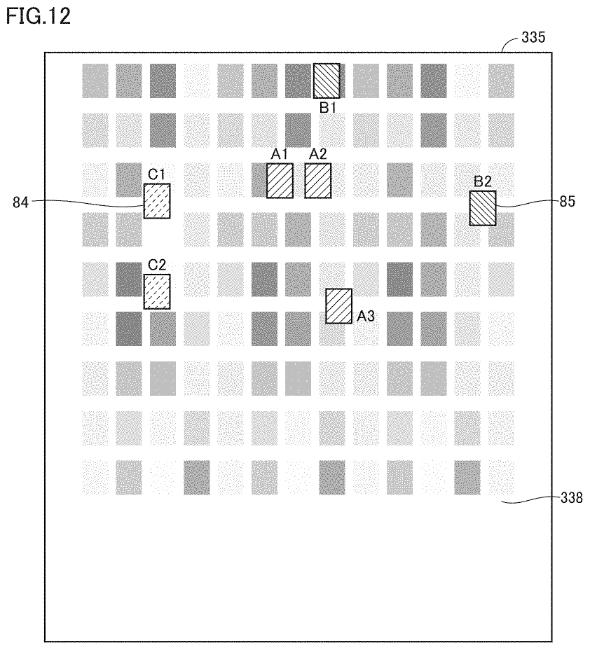

Each of FIGS. 10 to 12 illustrates colorimetry file 335 which is generated by controller 30 (i.e., CPU). When a print job that is based on colorimetry file 335 in FIG. 10 is executed, colorimetry file 335 instructs printer 140 to print a patch (patch 84, 85, or the like) of each of the spot colors designated by the user on sheet P at a position corresponding to each of the colorimetry positions designated by the user, without printing the image of job image data 333. When a print job that is based on colorimetry file 335 in FIG. 11 is executed, colorimetry file 335 instructs printer 140 to print the image of job image data 333 and to print a patch (patch 84, 85, or the like) of each spot color designated by the user on sheet P at a position (i.e., a position on the image) corresponding to each of the colorimetry positions designated by the user. When a print job that is based on colorimetry file 335 in FIG. 12 is executed, colorimetry file 335 instructs printer 140 to print an image of a standard wedge 338 on sheet P, and to print a patch (patch 84, 85, or the like) of each spot color designated by the user on sheet P at a position (i.e., position on the image of standard wedge 338) corresponding to each of the colorimetry positions designated by the user. Standard wedge 338 is used for normal colorimetry.

Colorimetry file generation unit 372 can determine a position at which a patch of a predetermined color (for example, an image 338 representing the standard wedge) is to be printed, based on the position at which the patch of the spot color is to be printed. For example, colorimetry file generation unit 372 determines the position as a position at which the patch of the predetermined color is placed in proximity to the patch of the spot color. The position at which the patch of the predetermined color is placed in proximity to the patch of the spot color includes a position at which the patch of the spot color overlaps with (is overlaid on) the patch of the predetermined color. In FIG. 12, the image representing standard wedge 338 is shown as the color patch image of the predetermined color different from the spot color, but the color patch image of the predetermined color is not limited thereto.

It should be noted that colorimetry file generation unit 372 may have the following modes: a mode in which one of colorimetry files 335 shown in FIGS. 10 to 12 is created; and a mode in which two or more of colorimetry files 335 are created in combination. For example, in the case of the mode in which the two or more of colorimetry files 335 are created in combination, in a scene of performing printing onto a plurality of sheets P in accordance with colorimetry files 355 that are based on the same image data 333, colorimetry file 355 in FIG. 10 can be applied to one sheet P, and colorimetry file 355 of FIG. 11 or 12 can be applied to another sheet P.

(c5. Color Verification Process)

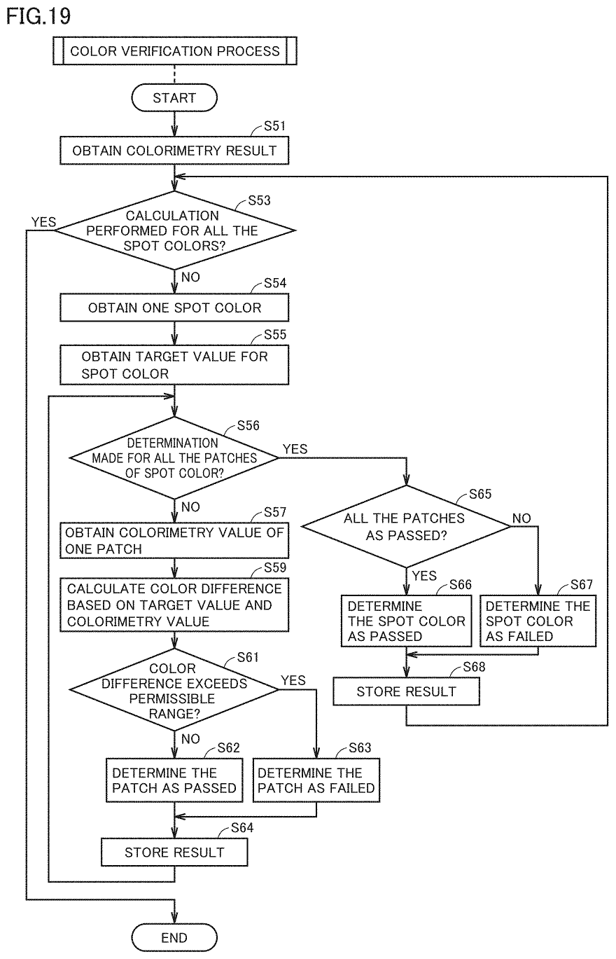

The following describes the color verification process in accordance with the flowchart of FIG. 19. Referring to FIG. 19, controller 30 obtains colorimetry result 336 from HDD 33 by searching for colorimetry result 336 (step S51).

Controller 30 determines whether or not color verification calculation has been ended for all the spot colors indicated by colorimetry result 336 (step S53). When it is determined that the color verification calculation has been ended for all the spot colors (YES in step S53), the process is ended. On the other hand, when it is determined that the color verification calculation has not been ended for all the spot colors (NO in step S53), the process proceeds to step S54.

Controller 30 obtains information of one spot color from colorimetry result 336, and obtains a target value for the one spot color from the obtained information (steps S54, S55). Controller 30 determines whether or not the color verification calculation has been performed for positions corresponding to the colorimetry positions of the one spot color (step S56). When it is determined that the color verification has not been ended for all the colorimetry positions of the one spot color (NO in step S56), controller 30 obtains a colorimetry value at each of the colorimetry positions of the spot color from colorimetry result 336, calculates a color difference that is based on the colorimetry value and the target value for the one spot color, compares the calculated color difference with permissible range 77 corresponding to the one spot color, and determines whether or not the color difference exceeds permissible range 77 based on the result of comparison (steps S57, S59, S61).

When controller 30 determines that the color difference does not exceed permissible range 77 (NO in step S61), controller 30 determines the colorimetry value of the colorimetry position as “Passed” (Success) (step S62). When controller 30 determines that the color difference exceeds permissible range 77 (YES in step S61), controller 30 determines the colorimetry value of the colorimetry position as “Failed” (Failure) (step S63). Controller 30 stores the result of color verification (“Passed” or “Failed”) for each of the colorimetry positions of the spot color as color verification result 337 (step S64). Thereafter, the process returns to step S56.

When controller 30 determines that the color verification has been ended for all the designated colorimetry positions of one spot color selected in step S54 (YES in step S56), controller 30 determines whether or not the color verification results of all the colorimetry positions of the one spot color indicate “Passed” (step S65). When controller 30 determines that the color verification results of all the colorimetry positions indicates “Passed” (Success) (YES in step S65), controller 30 determines the color verification of the one spot color as Success (step S66). Otherwise (NO in step S65), controller 30 determines the color verification of the one spot color as Failure (step S67). Controller 30 stores, into color verification result 337, the result of step S66 or S67 obtained for the one spot color (step S68). Thereafter, the process returns to step S53.

Thus, when the image of colorimetry file 335 is printed on sheet P by printer 140, color verification result 337 can indicate the color verification result of each spot color designated by the user on sheet P at the position corresponding to each of the colorimetry positions designated by the user.

### D. Program

The programs according to the flowcharts of FIGS. 16 to 20, color verification program 36, and the programs for implementing the functions of the respective units (screen generation unit 375 and color verification unit 37) of controller 30 shown in FIG. 6 are provided as programs executable by controller 30 or controller 20 of information processing apparatus 200. Controller 30 or controller 20 serves as a computer including a hardware processor. Each of the programs can be also provided as a program product with the program being recorded in a computer-readable recording medium such as a storage unit (flexible disk, CD-ROM (Compact Disk-Read Only Memory)) attached to the computer of server 300 or information processing apparatus 200 such as recording media 34-2, 26-2, ROMs 21, 31, RAMs 22, 32, and a memory card. Alternatively, each of the programs may be provided with the program being recorded in a recording medium such as a hard disk included in a computer. Further, each of the programs can be also provided by downloading the program via networks 400, 600. Each of the programs can be executed by one or more hardware processors such as the CPUs included in controllers 30, 20, or by a combination of a hardware processor and a circuit such as an ASIC (Application Specific Integrated Circuit) or an FPGA (Field Programmable Gate Array).

It should be noted that each of the programs may be such that required program modules of program modules provided as parts of an OS (Operating System) of a computer are invoked in a predetermined sequence at a predetermined timing to cause the processor to perform a process. In this case, the program itself does not include the modules, and the process is performed in cooperation with the OS. Such a program that does not include the modules can be also included in the program of the embodiment.

The program according to the embodiment may be provided with the program being incorporated in part of another program. Also in this case, the program itself does not include modules included in the other program, and causes the processor to perform a process in cooperation with the other program. Such a program incorporated in the other program can be also included in the program according to each embodiment.

In another aspect, each of the programs described above can be provided to image forming apparatus 100. In this case, each of the programs can be provided as a program product with the program being recorded in a computer-readable recording medium such as a storage unit (flexible disk, CD-ROM (Compact Disk-Read Only Memory)) attached to the computer of image forming apparatus 100 such as ROM, RAM, or memory card such as recording medium 176. Alternatively, each of the programs may be provided with the program being recorded in a recording medium such as a hard disk included in a computer. Further, each of the programs can be also provided by downloading the program via networks 400, 600. Each of the programs can be executed by one or more hardware processors such as the CPU included in controller 150, or by a combination of a hardware processor and a circuit such as an ASIC or FPGA.

### E. Advantages

A state of printer 140 is changed due to various factors such as deterioration of components with passage of time and environmental changes such as changes in ambient temperature or humidity. Also, characteristics of toner are also changed due to various factors. Hence, color reproducibility can be also varied due to these factors. On the other hand, in the printing industry, in the verification for color reproducibility, a spot color is a color having a special meaning for a user of a printed material because the spot color includes a logotype or a brand color that is a color representing a brand. Hence, there is a demand to frequently perform color verification in order to deal with the variation in color reproducibility.

In the present embodiment, with simple operations of interacting with controller 30 (more specifically, color verification unit 37) via the browser screen, the user causes controller 30 to create configuration data 334 and colorimetry file 335, causes printer 140 to execute a print job that is based on colorimetry file 335, and causes controller 30 to perform color verification. Thus, the above demand can be responded to.

In order to perform the colorimetry for the color verification by the user operating colorimeter 500 using the printed image that is based on colorimetry file 335 and that is formed on sheet P, the support message is presented to the user to readily specify a position to be subjected to the colorimetry on sheet P in accordance with guidance 132 and the presented image of window 130. Therefore, the user can readily specify a position to be subjected to the colorimetry on sheet P without requiring a special mechanism such as the one described in Japanese Laid-Open Patent Publication No. 2016-70697. Thus, the above demand can be responded to.

Although embodiments of the present invention have been described and illustrated in detail, the disclosed embodiments are made for purposes of illustration and example only and not limitation. The scope of the present invention should be interpreted by terms of the appended claims.

What is claimed is:

1. A color verification apparatus comprising a hardware processor, wherein
in accordance with a user operation, the hardware processor obtains one or more designated positions on an image, the one or more designated positions being one or more positions at which each of one or more designated colors designated for printing of the image is to be printed,
the hardware processor generates a printing file for causing a printer to print a patch of each of the one or more designated colors on a sheet at a position corresponding to each of the obtained one or more designated positions for the designated color, and
the hardware processor performs color verification based on a colorimetry value on the printed sheet at the position corresponding to each of the one or more designated positions and a target value for the designated color corresponding to the designated position.

2. The color verification apparatus according to claim 1, wherein
the hardware processor further generates, as the printing file, a first printing file for causing the printer to print the patch of each of the one or more designated colors on the sheet at the position corresponding to each of the obtained one or more designated positions for the designated color, and for causing the printer to print a patch of a predetermined color on the sheet, and
the hardware processor determines a position on the sheet at which the patch of the predetermined color is to be printed, based on the position on the sheet at which the patch of the designated color is to be printed.

3. The color verification apparatus according to claim 1, wherein the hardware processor further generates, as the printing file, a second printing file for causing the printer to print the patch of each of the one or more designated colors on the sheet at the position corresponding to each of the obtained one or more designated positions for the designated color, and for causing the printer to print the image on the sheet.

4. The color verification apparatus according to claim 1, wherein the hardware processor further causes a display to present the image, and obtains, as the one or more designated positions, one or more positions operated by a user on the presented image.

5. The color verification apparatus according to claim 1, wherein
the color verification includes comparing, with a threshold value by the hardware processor, a difference between the colorimetry value on the printed sheet at the position corresponding to each of the one or more designated positions and the target value for the designated color corresponding to the designated position, and
the hardware processor sets the threshold value based on the user operation.

6. The color verification apparatus according to claim 1, wherein the hardware processor causes a display to present the colorimetry value at the position corresponding to each of the obtained one or more designated positions.

7. The color verification apparatus according to claim 6, wherein the hardware processor causes the display to present the image and present a color patch on the image at each of the one or more designated positions, the color patch representing the colorimetry value at the position corresponding to the designated position.

8. The color verification apparatus according to claim 1, wherein the hardware processor further generates, as the printing file, a third printing file for causing the printer to print the patch of each of the one or more designated colors on the sheet at the position corresponding to each of the one or more designated positions and for causing the printer to print an identifier in proximity to the patch printed at the position corresponding to each of the one or more designated positions, the identifier identifying the designated position.

9. A color verification method comprising:
in accordance with a user operation, obtaining one or more designated positions on an image, the one or more designated positions being one or more positions at which each of one or more designated colors designated for printing of the image is to be printed;
generating a printing file for causing a printer to print a patch of each of the one or more designated colors on a sheet at a position corresponding to each of the obtained one or more designated positions for the designated color; and
performing color verification based on a colorimetry value on the printed sheet at the position corresponding to each of the one or more designated positions and a target value for the designated color corresponding to the designated position.

10. The color verification method according to claim 9, wherein
the printing file includes a first printing file for causing the printer to print the patch of each of the one or more designated colors on the sheet at the position corresponding to each of the obtained one or more designated positions for the designated color, and for causing the printer to print a patch of a predetermined color on the sheet,
the method further comprising determining a position on the sheet at which the patch of the predetermined color is to be printed, based on the position on the sheet at which the patch of the designated color is to be printed.

11. The color verification method according to claim 9, wherein the printing file includes a second printing file for causing the printer to print the patch of each of the one or more designated colors on the sheet at the position corresponding to each of the obtained one or more designated positions for the designated color, and for causing the printer to print the image on the sheet.

12. The color verification method according to claim 9, further comprising causing a display to present the image, and obtaining, as one or more designated positions, one or more positions operated by a user on the presented image.

13. The color verification method according to claim 9, further comprising:
comparing, with a threshold value, a difference between the colorimetry value on the printed sheet at the position corresponding to each of the one or more designated positions and the target value for the designated color corresponding to the designated position; and
setting the threshold value based on the user operation.

14. The color verification method according to claim 9, further comprising causing a display to present the colorimetry value at the position corresponding to each of the obtained one or more designated positions.

15. The color verification method according to claim 14, wherein the causing of the display to present the colorimetry value includes causing the display to present the image and present a color patch on the image at each of the one or more designated positions, the color patch representing the colorimetry value at the position corresponding to the designated position.

16. The color verification method according to claim 9, wherein the printing file includes a third printing file for causing the printer to print the patch of each of the one or more designated colors on the sheet at the position corresponding to each of the one or more designated positions and for causing the printer to print an identifier in proximity to the patch printed at the position corresponding to each of the one or more designated positions, the identifier identifying the designated position.

17. A non-transitory computer readable recording medium storing a computer readable program for causing a computer to perform a color verification method comprising:
in accordance with a user operation, obtaining one or more designated positions on an image, the one or more designated positions being one or more positions at which each of one or more designated colors designated for printing of the image is to be printed;
generating a printing file for causing a printer to print a patch of each of the one or more designated colors on a sheet at a position corresponding to each of the obtained one or more designated positions for the designated color; and
performing color verification based on a colorimetry value on the printed sheet at the position corresponding to each of the one or more designated positions and a target value for the designated color corresponding to the designated position.
